(19) United States
(12) Patent Application Publication
(10) Pub. No.: US 2006/0087622 A1
(43) Pub. Date: Apr. 27, 2006

(54) Projector apparatus and methods

(76) Inventor: Stephen J. Brown, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/035,495

(22) Filed: Jan. 14, 2005

Related U.S. Application Data
(60) Provisional application No. 60/621,171, filed on Oct. 21, 2004.

(51) Int. Cl. G03B 21/18

(52) U.S. Cl. 353/57

(57) ABSTRACT

In accordance with at least one embodiment of the present invention, data can be read from an optical element, and an operational parameter of a projector component can be adjusted based on the data.

This application claims the benefit of U.S. Provisional Application No. 60/621,171, filed Oct. 21, 2004.

### BACKGROUND

Projector light sources are generally available in a number of various power ratings. The amount of heat produced by the light source can be generally proportional to the power rating of the light source. Thus, the level of cooling provided by a cooling device can, in some circumstances, be inadequate or over adequate for cooling the light source, depending upon the relative power rating of the light source that is installed in the projector.

Moreover, the light frequency spectral output of projector light sources can be different, depending on the type of light source, and/or its power rating, and the like. Thus, the light frequency spectral characteristics of the projected image can vary noticeably, depending upon the type and/or power rating of the light source that is installed in the projector.

### DESCRIPTION OF THE DRAWINGS

FIG. 1 depicts a schematic representation of an apparatus in accordance with at least one embodiment of the present invention.

FIG. 2 depicts a flow diagram in accordance with at least one embodiment of the present invention.

FIG. 3 depicts another flow diagram in accordance with at least one embodiment of the present invention.

### DETAILED DESCRIPTION

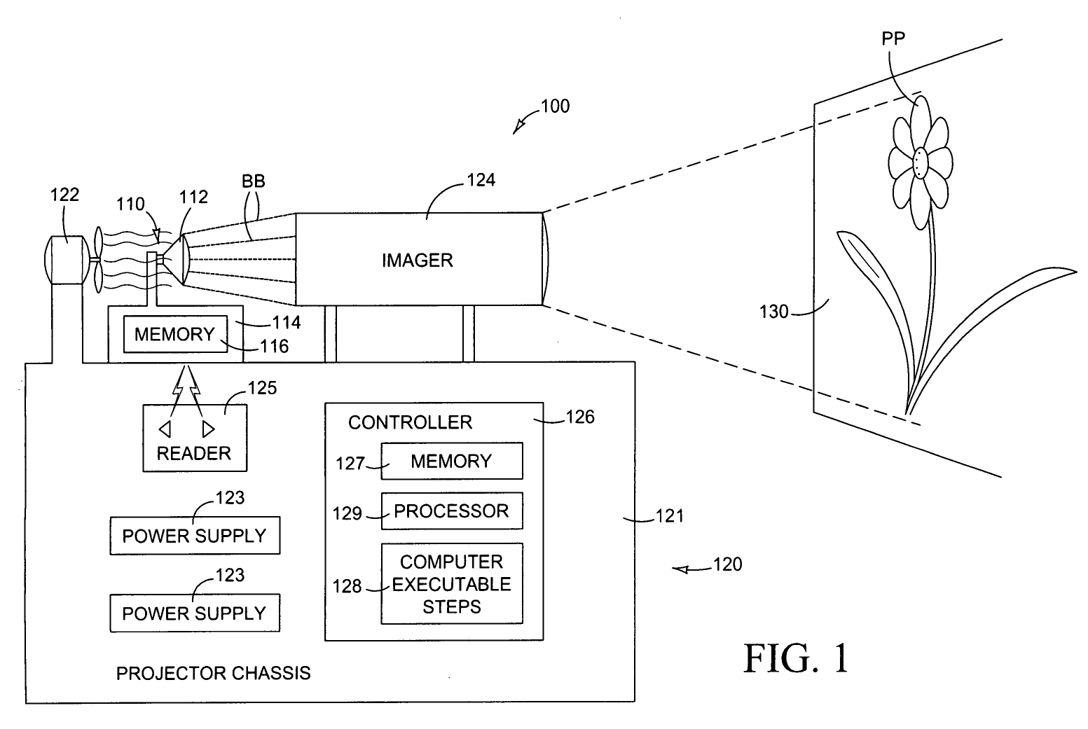

With reference to the drawings, FIG. 1 depicts a schematic representation of a system or apparatus 100 in accordance with at least one embodiment of the present invention. The apparatus 100 includes a lamp module 110 that is configured to function as a projector light source. The lamp module 110 can include a burner 112 that is configured to produce light, which can be in the general form of a light beam BB. The light beam BB produced by the burner 112 can be employed in the operation of the apparatus 100 to produce a projected image PP as is discussed in greater detail below.

The lamp module 110 can include a header 114. The header 114 can be configured to operatively support the burner 112. The header 114 can also include various connections such as power connections (not shown), which enable the burner 112 to receive operational power. The lamp module 110 can include an information storage device, or memory device 116. The memory device 116 can be operatively supported on the header 114 and/or on the burner 112.

The memory device, or data record, 116 can have any of a number of possible forms. For example, the form of the memory device 116 can include, but is not limited to, the form of a solid state memory “chip,” or the form of a label or panel having a machine-readable symbol imprinted thereon. Such a panel can be a portion of the header 114, or a portion of the burner 112. The machine-readable symbol can be, for example, a bar code or the like that is machine readable by way of optical means.

Information, such as machine-readable data can be stored on the lamp module 110. Machine-readable data shall be broadly understood to mean data that can be automatically read by a machine and/or device, wherein the data is thereby rendered usable in connection with the operation of the machine and/or device.

Machine-readable data can be stored on the lamp module 110 by way of the memory device 116. Accordingly, the machine-readable data can have any of a number of possible forms. For example, the machine-readable data can be in the form of digital data that is stored in the memory device 116 when the memory device is in the form of a memory chip. The machine-readable data can be in the form of optically-readable code when the memory device 116 is in the form of a machine-readable symbol that is imprinted on a label and/or panel or the like.

Thus, the machine-readable data can be read from the lamp module by way of any of a number of possible machine-readable data reading means. For example, the machine-readable data can be read electronically, such as being read by a reading means comprising a digital processor or the like. Or, the machine-readable data can be read from the lamp module optically, for example. In an exemplary embodiment the machine-readable data stored on the lamp module 110 is indicative of at least one operational characteristic of the projector lamp module 110.

An operational characteristic of the lamp module 110 can include, but is not limited to, a light frequency spectral characteristic of light produced by the burner 112, or a power rating of the lamp module, or an intensity of light produced by the lamp module. An operational characteristic of the lamp module shall be broadly understood to mean information or terminology that characterizes any aspect of the lamp module 110.

The machine-readable data stored on the lamp module 110 need not be in the form of specific information in regard to an operational characteristic of the lamp module. That is, the machine-readable data stored on the lamp module 110 need only to be “indicative” of an operational characteristic of the lamp module. Stated otherwise, the machine-readable data stored on the lamp module 110 is at least a unique identifier, such as a serial number, or the like, from which unique identifier an operational characteristic of the lamp module can be ultimately determined.

In such an instance, for example, machine-readable data stored on the lamp module 110, which data is a serial number or the like can suggestively indicate the power rating of the lamp module, and/or the light frequency spectral characteristics of the lamp module. That is, although a serial number most likely does not specifically and/or expressly indicate an operational characteristic of the lamp module, an operational characteristic can be ultimately determined from the serial number.

For example, machine-readable data stored on the lamp module in the form of a serial number can be read from the lamp module and loaded into the memory of a processor or the like (discussed further below). The serial number can then be compared by operation of a processor to a list of serial numbers stored in the processor or stored in a remote memory device, wherein the list of serial numbers can indicate corresponding specific operational characteristics of a given lamp module. In this manner, an operational characteristic of a given lamp module 110 can be determined from machine-readable data stored on the lamp module, which data is generally in the form of a serial number of the given lamp module.

On the other hand, the machine-readable data that is stored on the lamp module 110 can specifically and/or expressly indicate an operational characteristic of the lamp module. That is, the machine-readable data stored on the lamp module 110 can specifically indicate the power rating of the lamp module, and/or a light frequency spectral characteristic of the lamp module without further determination or analysis as in the case of a serial number or the like.

With continued reference to FIG. 1, the apparatus 100 can include a projector unit 120. The projector unit 120 can be configured to operatively support the lamp module 110. Moreover, the projector unit 120 can be configured to operatively support the lamp module 110 in a removable manner. In such an instance, a given lamp module 110 can be removed from the projector unit 120. Similarly, a replacement lamp module 110 can be put into an operatively supported position on the projector unit 120. Stated otherwise, the lamp module 110 can be configured so as to be removed and replaced with respect to the projector unit 120.

The projector unit 120 can include a chassis 121. The projector unit 120 can also include a cooling device 122. The cooling device 122 can be operatively supported on the chassis 121. The cooling device 122 is configured to provide a level of cooling to the lamp module 110. That is, the cooling device 122 can be configured to remove and/or dissipate heat energy from the lamp module 110 and/or from an area immediately surrounding the lamp module. Such heat energy can be produced by the lamp module 110 as a by-product of light production during normal operation of the lamp module.

The projector unit 120 can include a reader 125. The reader 125 can be configured to search for machine-readable data stored on the lamp module 110. The reader 125 can be configured to read machine-readable data that is stored on the lamp module 110. For example, the reader 125 can be configured to automatically read any machine-readable data that is stored on the lamp module 110, and to download the machine-readable data.

The reader 125 can be configured to perform such data reading functions in any of a number of various manners. That is, the reader 125 can be configured to read machine-readable data from the lamp module 110 by way of any of a number of known means for reading machine-readable data. Such means for reading data can include, but is not limited to, means for electronically reading digital data from a memory chip, and/or means for optically reading a bar code or other type of machine-readable symbol.

The reader 125 can be substantially in the form of a radio frequency transmitter/scanner that is configured to read machine-readable data from a memory chip by way of wireless radio frequency scanning means. As a further example, the reader 125 can be substantially in the form of an optical scanner that is configured to perform optical scanning of machine-readable data in the form of a printed machine-readable symbol or the like such as a bar code, or other machine-readable graphics.

The projector unit 120 can include a controller 126. The term controller shall be broadly understood to mean any control means that is configured to produce control signals for controlling any aspect or operational parameter of the apparatus 100. The controller 126 can include any of a number various forms of control means including control electronics and/or control circuitry that is configured to produce control signals.

Such control electronics can be substantially in the form of and/or include a controller memory 127 and/or a processor 129 that can be communicatively linked with the controller memory 127. The controller 126 can be configured to contain and/or operatively contain a set of computer executable instructions 128, which can be in the form of computer readable medium. The computer readable medium can be fixed to the controller, or can be removable from the controller. The function and operation of the controller 126 is discussed in greater detail below.

An imager 124 can be included in the projector unit 120 and can be communicatively linked with the controller. The imager 124 is configured to produce a projected image PP in conjunction with the lamp module 110. That is, light produced by the lamp module 110 can be employed by the imager 124 to produce the projected image PP. The imager 124 can have any of a number of possible forms that include, but are not limited to, a conventional film projector, a Digital Mirror Device projector, a Liquid Crystal Display Device projector, and the like. The projected image PP can be a still image, or can be a moving image.

In an exemplary embodiment, the imager includes, and/or can be substantially in the form of, a spatial light modulator (not shown) that can include one or more spatial light modulators. In general, a spatial light modulator includes an array of pixel elements that are utilized in combination with the lamp module 112 to form pixels on the screen 130 to define the projected image PP.

Each pixel element can be controlled to adjust an intensity and/or “on time” of each pixel to determine a perceived intensity of the pixel. Examples of known spatial light modulators include devices such as “micromirrors”, “digital light processors”, and “liquid crystal display”, or “LCD” panels. The imager can include one or more color filters (not shown) configured to produce filtered light having given light frequency spectral characteristics.

The projector unit 120 can also include at least one power supply 123. The power supply 123 can be configured to supply power, such as electrical power. Power from the power supply 123 can be distributed to various components of the apparatus 100. For example, one of the power supplies 123 can be configured to supply power to drive the lamp module 110. Similarly, one of the power supplies 123 can be configured to supply power to the cooling device 122. Similarly, additional power supplies (not shown) can be configured to supply power to the reader 125, and/or to the controller 126, and/or to the imager 124.

The controller 126 can be configured to control various operational parameters or aspects of the apparatus 100. For example, the controller 126 can be configured to control the production of light by the lamp module 110. That is, the controller 126 can direct one of the power supplies 123 to send power to the lamp module 110, which can cause illumination of the lamp module. Likewise, the controller 126 can direct the power supply 123 to stop sending power to the lamp module 110.

Light that is produced by the lamp module 110 can be directed at the imager 124 to produce the projected image PP. Accordingly, the apparatus 100 can include a projection surface, or screen 130, onto which the projected image PP can be projected by the imager 124. The term “screen” shall be broadly understood to include anything onto which the image PP can be projected, and from which the image can be viewed.

Additionally, the exemplary depiction of the screen 130 included herein is not intended to be limiting in regard to any specific configuration or use of the screen. Specifically, for example, although the screen 130 is depicted in the accompanying figures as a “front projection” screen, the screen can be configured as a “rear projection” screen in accordance with at least one embodiment of the present invention.

The controller 126 can be configured to control at least one operational parameter of the imager 124. That is, the controller 126 can be configured to control an aspect or characteristic of the projected image PP. For example, the controller 126 can be configured to control the operation of the imager 124 whereby a light frequency characteristic or hue or intensity of the projected image PP is effected. More particularly, the controller can provide control signals to the imager 124 to define the hue and intensity for each pixel that in turn defines image PP.

The controller 126 can also be configured to control at least one operational aspect of various other projector components. For example, the controller 126 can be configured to control at least one operational aspect of the cooling device 122. More specifically, the controller 126 can be configured to control the level of cooling produced by the cooling device 122.

In an exemplary embodiment of the present invention, the cooling device 122 can include, or can be substantially in the form of, a fan or blower. The controller 126 can be configured to control the rotational speed of the fan, for example, by controlling the level of power supplied to the cooling device 122 by the corresponding power supply 123.

The controller 122 can be configured to control operational aspects or operational parameters of one or more projector components in response to, or as a function of, the information or data stored on the lamp module 110. More specifically, the reader 125 can read information or data from the lamp module and relay the information or data to the controller 126.

The controller 126 can receive the information or data, and in response, the controller can adjust one or more control parameters with respect to one or more projector components. The projector components to be controlled in this manner can include, for example, the imager 124 and/or the cooling device 122.

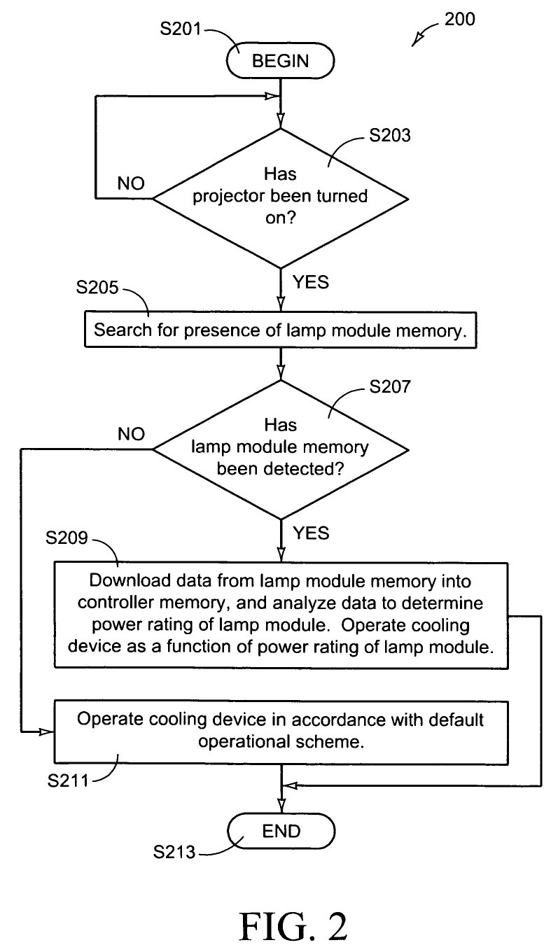

With continued reference to the drawings, FIG. 2 depicts a flow diagram 200 in accordance with at least one embodiment of the present invention. The flow diagram 200 begins at S201, and describes the basic steps of controlling at least one projector component as a function of information or data received from another projector component, such as the lamp module.

From S201, the flow diagram 200 proceeds to step S203, which is a query. The query of step S203 asks whether the projector has been turned on. If the answer to the query of S203 is “no,” then the flow diagram 200 remains in a continuous loop, wherein the query of S203 is repeatedly asked until the answer to the query is “yes.”

If the answer to the query of step S203 is “yes,” then the flow diagram 200 moves to the step of S205. In accordance with the step S205, a search for the presence of a lamp module memory is undertaken. In other words, in accordance with step S205, a reader can search for machine-readable data stored on the lamp module.

That is, the search for the lamp module memory can be performed, for example, by directing a reader (such as the reader 125 shown in FIG. 1) to read data from a lamp module memory. As is discussed above, the lamp module memory can have any of a number of possible forms, such as a digital memory chip or a panel or label having an optically readable symbol imprinted thereon.

The next step in the flow diagram 200 is that of S207, which is a query. The query of step S207 asks whether a lamp module memory has been detected. If the answer to the query of step S207 is “yes,” then the flow diagram 200 moves to step S209. Step S209 specifies that the data from the lamp memory module is downloaded into the controller memory, and that the data is then analyzed by operation of a processor or the like to determine an operational characteristic of the lamp module, wherein the operational characteristic is a power rating of the lamp module.

Furthermore, in accordance with step S209, an operational parameter of the projector unit is determined as a function of the data. For example, as is implied by step S209, the operational parameter can be the operation of a cooling device that is configured to provide a level of cooling to the lamp module. Accordingly, the cooling device can be operated as a function of the power rating of the lamp module to provide a level of cooling based on the power rating of the lamp module as indicated by the data stored on the lamp module.

It is noted that certain types of light sources, such as lamps, generally tend to produce an amount of heat that is directly proportional to the power rating of the lamp, or light source. That is, lamps of a given type having relatively low power ratings will generally produce relatively lower amounts of heat. Conversely, lamps of a given type having relatively high power ratings will generally produce relatively higher amounts of heat.

Thus, if the data indicates that the power rating of the lamp module is relatively low, then the controller can cause the cooling device to operate at a relatively low output, at which a relatively low level of cooling is provided to the lamp module. Specifically, for example, if the cooling device includes a fan, then the fan can be operated at a relatively low speed, or can be operated at a relatively low duty cycle. Reduction of fan speed and/or reduction of fan duty cycle can result in reduction of noise associated with fan operation, yet adequate cooling can be provided to the lamp module.

If the machine-readable data that is read from the lamp module indicates that the power rating of the lamp module is relatively high, then the controller can cause the cooling device to operate at a relatively high output, at which a relatively high level of cooling is provided to the lamp module. Specifically, for example, if the cooling device includes a fan, then the fan can be operated at a relatively high speed, or can be operated at a relatively high duty cycle. From step S209, the flow diagram 200 ends at S213.

If the answer to the query of step S207 is “no,” then the operational parameter can be set to a default value. That is, for example, when the operational parameter is the operation of the cooling device, then the controller can cause the cooling device to be operated in accordance with a default operational scheme when no machine-readable data is detected on the lamp module, and/or when no lamp module memory is detected.

A default operational scheme can be, for example, an operational scheme in accordance with which the cooling device provides an average level of cooling to the lamp module. Or, a default operational scheme can be an operational scheme in accordance with which the cooling device provides the highest level of cooling to the lamp module. From step S211, the flow diagram ends at step S213.

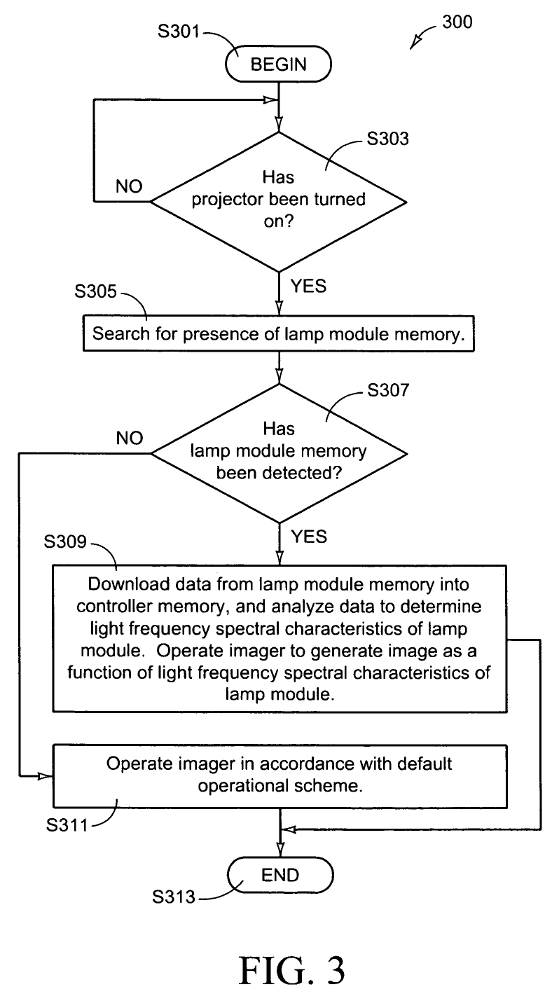

With further reference to the drawings, FIG. 3 depicts another flow diagram 300 in accordance with at least one embodiment of the present invention. The flow diagram 300 begins at S301, and describes another example of controlling operational aspects or parameters of a projector component as a function of the information or data received from another projector component such as the lamp module.

From S301, the flow diagram 300 proceeds to step S303, which is a query. The query of step S303 asks whether the projector has been turned on. If the answer to the query of S303 is “no,” then the flow diagram 300 remains in a continuous loop, wherein the query of S303 is repeatedly asked until the answer to the query is “yes.”

If the answer to the query of step S303 is “yes,” then the flow diagram 300 moves to the step of S305. In accordance with the step S305, a search for the presence of a lamp module memory is undertaken. The search for the lamp module memory can be performed, for example, by directing a reader (such as the reader 125 shown in FIG. 1) to read data from a lamp module memory.

The next step in the flow diagram 300 is that of S307, which is a query. The query of step S307 asks whether a/lamp module memory has been detected. If the answer to the query of step S307 is “yes,” then the flow diagram 300 moves to step S309. Step S309 specifies that the data from the lamp memory module is downloaded into the controller memory, and that the data is then analyzed in order to determine an operational characteristic of the lamp module, wherein the operational characteristic is a light frequency spectral characteristic of light produced by the lamp module.

Furthermore, in accordance with step S309, an operational parameter of the projector unit is determined as a function of the data. For example, as is implied by step S309, the operational parameter can be the operation of the imager to produce a projected image having given light frequency spectral characteristics. Accordingly, the imager can be operated to produce the projected image as a function of the light frequency spectral characteristics of the lamp module. In other words, the imager can adjust the light frequency spectral characteristics of the projected image based on the data stored on the lamp module.

For example, if the machine-readable data stored on the lamp module indicates that the lamp module produces light having a given light frequency spectral characteristic, then the controller can cause the imager operate to compensate for the given light frequency spectral characteristic in order to produce a projected image that has desired light frequency spectral characteristics. That is, the operation of the imager can be controlled as a function of the machine-readable data stored on the lamp module to produce a projected image having desired color characteristics.

As a more specific example, the imager can be configured to digitally generate a projected image having neutral color characteristics. The data stored on a given lamp module can indicate that the lamp module is of a given type that typically produces light that is skewed, or biased, toward a specific color, or light frequency characteristics. In such an instance, the controller can cause the imager to “offset,” or compensate for, the skewed light frequency characteristics of the lamp module in order to produce an image having the desired neutral light frequency spectral characteristics.

More specifically, for example, if the machine-readable data stored on given lamp module indicates that the lamp module produces light that is skewed toward the red color spectrum, then the controller can direct the imager to attempt to increase red light filtering functions in order to offset, or compensate for the skewed light frequency spectral characteristics of the given lamp module. From step S209, the flow diagram 200 ends at S213.

If the answer to the query of step S307 is “no,” then the operational parameter can be set to a default value. That is, for example, when the operational parameter is the operation of the imager to produce an image as is described above, then the controller can cause the imager to be operated in accordance with a default operational scheme when no data is detected as being stored on the lamp module, and/or when no lamp module memory is detected.

A default operational scheme for the imager can be, for example, an operational scheme in accordance with which the controller assumes that the lamp module produces light having neutral light frequency spectral characteristics. In such an instance, the controller can direct the imager to generate a projected image without compensating for any potential skewed light frequency spectral characteristics of the lamp module.

Or, a default operational scheme for the imager can be an operational scheme in accordance with which the imager produces a projected image under the assumption that the lamp module has light frequency spectral characteristics of a typical, or average, lamp module. That is, the light frequency spectral characteristics of a typical lamp module can be determined by the controller based on an average of all lamp module characteristics read from the respective lamp module memories for a group of lamp modules that have been previously installed on, and then removed from, the projector apparatus. From step S311, the flow diagram ends at step S313.

With reference now to FIG. 1, the computer executable steps 128, which can be in the form of a computer readable medium, can be configured to cause the controller 126 to perform any or all of the functions and/or steps described above. That is, the computer executable steps 128 can be configured, for example, to cause a controller to read machine-readable data stored on a lamp module. The computer executable steps 128 can be further configured to cause the controller 126 to then provide a given level of cooling to the lamp module 110, wherein the given level of cooling is determined by the controller as a function of the machine-readable data.

The computer executable steps 128 can be configured, for example, to cause a controller 126 to read machine-readable data from a lamp module 110, which is supported on a projector unit 120. The computer executable steps 128 can be further configured to cause the controller 126 to then operate an imager 124 to produce a projected image PP, wherein the light frequency spectral characteristics of the projected image are adjusted by the controller and/or by the imager as a function of the data stored on the lamp module.

In accordance with at least one embodiment of the present invention, a method includes providing a projector system that includes a lamp power supply and a replaceable projector lamp module configured to be coupled to the lamp power supply. The projector system also includes a projector component that is associated with the projector lamp module.

The association of one projector component with another projector component shall be broadly defined to mean that the operating set-points and/or operating parameters of one projector component are affected by the operational characteristics of the other projector component. Furthermore, each of the projector components that are “associated” with one another are configured to function discretely.

Stated otherwise, two projector components that are associated with one another operate synergistically and/or cooperatively to produce an image and/or to provide increased quality and/or reliability of service. However, one projector component does not operate or drive another projector component with which it is associated. For example, a projector component that is associated with a projector lamp module cannot be a portion of the lamp module and cannot be a power supply or the like that drives the lamp module.

Instead, a projector component that is associated with a lamp module can be, for instance, a cooling device that is configured to cool the lamp module. Furthermore, a projector component that is associated with a lamp module can be, for example, an imager that is configured to function cooperatively with the lamp module to produce a projected image.

The method can further include providing information such as machine-readable data on the replaceable projector lamp module. The machine-readable data can be stored on the lamp module as digital data in a memory device such as a memory chip that is supported on the lamp module. The machine-readable data can be stored as optically readable data, such as an optically readable symbol, which can include a bar code.

The machine-readable data can be indicative of an operational characteristic of the projector lamp module. For example, the operational characteristic can be a power rating of the lamp module. Or, the operational characteristic can be a light frequency spectral characteristic of light produced by the lamp module. The operational characteristic can also be an intensity of a light beam produced by the lamp module.

The machine-readable data can be in the form of a unique identifier such as a serial number, or the like. The method can include acquiring an operational characteristic of the lamp module based on the unique identifier that machine read from the lamp module. For example, acquiring the operational characteristic based on the unique identifier can include searching a memory device containing a group of unique identifiers having corresponding operational characteristics listed. Searching a memory device can include searching the Internet, or accessing a website and/or server that contains the group of unique identifiers.

The method further includes reading the machine-readable data from the lamp module and adjusting an operational parameter of the projector component as a function of the machine-readable data. The projector component can be a cooling device and the operational parameter can be a level of cooling provided to the lamp module. That is, the cooling can be provided by a cooling device that is controlled by a controller as a function of the machine-readable data.

The projector component can be a power supply for a cooling device that provides cooling to the lamp module. The cooling device can include a fan or the like. The process of adjusting the operational parameter of the projector component can include adjusting the rotational speed of the fan. For example, the machine-readable data can indicate that the lamp module functions satisfactorily with a given level of cooling. A controller means, such as a controller and/or control electronics or the like which can be included in the projector system, can be configured to adjust the speed of the fan in order to provide the level of cooling to the lamp module as indicated by the machine-readable data.

The projector component can include an imager that is configured to produce a projected image in cooperation with the lamp module. The imager can be substantially in the form of a Digital Mirror Device projector, a Liquid Crystal Display projector, or a conventional film projector. The operational parameter can be a light frequency spectral characteristic of an image produced by the imager.

The imager can include a spatial light modulator. A controller can be included in the projector system as is discussed above. The controller can be configured to generate control signals that are sent to the spatial light modulator, wherein the spatial light modulator is directed to generate an image and/or to change and/or adjust at least one characteristic of an image. The step of adjusting an operational parameter of the projector component can include adjusting and/or defining control signals sent to the spatial light modulator. That is, the machine-readable data can define an operational parameter of the spatial light modulator.

The preceding description has been presented only to illustrate and describe methods and apparatus in accordance with respective embodiments of the present invention. It is not intended to be exhaustive or to limit the disclosure to any precise form disclosed. Many modifications and variations are possible in light of the above teaching. It is intended that the scope of the invention be defined by the following claims.

What is claimed is:

1. A method, comprising:
reading data from an optical element; and,
adjusting an operational parameter of a projector component based on the data.

2. The method of claim 1, wherein the projector component is a power supply for a cooling system for the optical element.

3. The method of claim 2 wherein the cooling system includes a fan and wherein adjusting an operational parameter of the projector component includes adjusting a rotational speed of the fan.

4. The method of claim 1, wherein the projector component includes an imager.

5. The method of claim 4 wherein the imager includes a spatial light modulator and wherein adjusting an operational parameter of the projector component includes defining or adjusting control signals sent to the spatial light modulator.

6. The method of claim 1, and wherein the data is indicative of a light characteristic of the optical element.

7. The method of claim 6, and wherein the light characteristic of the optical element is a light frequency spectral characteristic.

8. The method of claim 6, and wherein the light characteristic of the optical element is a light intensity characteristic.

9. The method of claim 1, and wherein the data is stored as digital electronic data in a memory device supported on the optical element.

10. The method of claim 1, and wherein the data is stored as optically readable data.

11. The method of claim 1, and wherein:
the data is in the form of a unique identifier; and,
the method further comprises acquiring an operational characteristic of the optical element based on the unique identifier.

12. The method of claim 11, and wherein acquiring an operational characteristic of the optical element based on the unique identifier comprises searching a memory device for specific data matching the unique identifier.

13. The method of claim 1, and wherein the operational parameter is a level of cooling provided to the optical element.

14. The method of claim 1, and wherein the operational parameter is a light frequency spectral characteristic of an image produced, at least in part, by the optical element.

15. The method of claim 1, and wherein the optical element is at least a portion of a Digital Mirror Device projector.

16. The method of claim 1, and wherein the optical element is at least a portion of a Liquid Crystal Display projector.

17. An apparatus, comprising:
a lamp; and,
data stored on the lamp, the data being indicative of an operational characteristic of a projector component.

18. The apparatus of claim 17, and wherein the data is indicative of a power rating of the lamp.

19. The apparatus of claim 17, and wherein the data is indicative of a light characteristic of the lamp.

20. The apparatus of claim 17, and further comprising the projector component, wherein the projector component comprises a reader configured to read the data from the lamp.

21. The apparatus of claim 20, and further comprising a controller operatively supported by the projector component and configured to adjust an operational parameter of the projector component based on the data.

22. The apparatus of claim 17, and further comprising a memory device supported by the lamp, wherein the data is digital data stored in the memory device.

23. The apparatus of claim 17, and wherein the data is substantially in the form of optically readable data.

24. A projector, comprising:
a reader supported by the projector and configured to read the data from a lamp; and,
a controller configured to control an operational parameter of a projector component based on the data.

25. The projector of claim 24, and further comprising a cooling system supported by the projector and configured to cool the lamp, wherein the operational parameter is a level of cooling provided by the cooling system.

26. The projector of claim 24, and further comprising an imager supported by the projector and configured to generate an image by employing light produced by the lamp, wherein the operational characteristic is a light frequency spectral characteristic of the lamp.

27. A projector apparatus, comprising:
a means for storing data at a lamp; and,
a means for adjusting an operational parameter of a projector component associated with the lamp based on the data.

28. The apparatus of claim 27, and further comprising a means for cooling the lamp, wherein the operational parameter is a level of cooling provided by the means.

29. The apparatus of claim 27, and further comprising a means for generating an image, wherein the operational parameter is a light frequency spectral characteristic of the image.

30. A computer readable medium comprising computer executable steps configured to cause a processor to:
read data stored at a lamp; and,
adjust an operational parameter of a projector component as a function of the data.

31. The apparatus of claim 30, wherein the operational parameter is a level of cooling provided to the lamp.

32. The apparatus of claim 30, wherein:
the projector component is configured to produce a projected image; and,
the operational parameter is a light frequency spectral characteristic of the projected image.

33. The apparatus of claim 30, wherein the operational parameter defines an operating aspect of a spatial light modulator.

34. A projector system, comprising:
a first projector component;
a second projector component configured to operate in cooperation with the first projector component, the second projector component including a data record; and,
control electronics that receive information from the data record and in response adjust an operational parameter of the first projector component.

35. The projector system of claim 34, further comprising a power supply configured to supply power to the second projector component when the second projector component is properly installed in the projector system.

36. The projector system of claim 34, wherein the first projector component is an imager, and wherein the information defines at least one operational parameter of the imager.

37. The projector system of claim 34, wherein the first component is configured to modulate light originating from the second component, and wherein the information defines at least one aspect of the light modulation performed by the first component.

38. The projector system of claim 34, wherein the second component is a lamp.
